(19) United States
(12) Patent Application Publication
(10) Pub. No.: US 2025/0190597 A1
(43) Pub. Date: Jun. 12, 2025

(54) PRIVACY THREAT DETECTION

(71) Applicant: DELL PRODUCTS L.P., Round Rock, TX (US)

(72) Inventors: Karunakar Palicherla Reddy, Austin, TX (US); Fnu Jasleen, Austin, TX (US)

(73) Assignee: DELL PRODUCTS L.P., Round Rock, TX (US)

(21) Appl. No.: 18/535,967

(22) Filed: Dec. 11, 2023

(51) Int. Cl. G06F 21/62; G06V 10/764; G10L 17/00

(52) U.S. Cl. CPC G06F 21/62; G06V 10/764; G10L 17/00

(57) ABSTRACT

Techniques for identifying potential privacy threats are described. One example method includes identifying a registered user physically located proximate to the computer system based on signals from one or more sensors of the computer system; in response to identifying the registered user, operating the computer system at a first privacy level; identifying a potential privacy threat physically located proximate to the computer system based on the signals from the sensors, wherein the potential privacy threat is separate from the registered user; and in response to identifying the potential privacy threat, operating the computer system at a second privacy level different from the first privacy level.

### TECHNICAL FIELD

The present disclosure relates in general to information handling systems, and more particularly to techniques for detecting privacy threats in information handling systems.

### BACKGROUND OF THE INVENTION

Many computer systems can detect the physical presence of a user near the system. This ability to detect user presence can allow the system to be contextually aware of user's proximity to the system, the user's attention to the system, the environment in which the user is using the system, and other information. For example, a system can automatically wake up from a low power state in response to detecting the presence of a user, and can initiate facial recognition to verify the user's identity to quickly log them into the system. A system can also lock itself when it detects that no user is present. User presence can be detected, for example, by analyzing captured video signals from a low power camera device, audio signals from a microphone, or other signals or combinations of signals.

### SUMMARY OF THE INVENTION

In accordance with embodiments of the present disclosure, a method for identifying potential privacy threats includes identifying a registered user physically located proximate to the computer system based on signals from one or more sensors of the computer system; in response to identifying the registered user, operating the computer system at a first privacy level; identifying a potential privacy threat physically located proximate to the computer system based on the signals from the sensors, wherein the potential privacy threat is separate from the registered user; and in response to identifying the potential privacy threat, operating the computer system at a second privacy level different from the first privacy level.

In some cases, the signals from the sensors include one or more of video signals, audio signals, ultrasound signals, WiFi Doppler signals, ultra wideband (UWB) signals, or radio frequency (RF) radar signals.

In some implementations, the potential privacy threat includes at least one of a non-registered user onlooker viewing a display of the computer system, a non-registered user listener listening to audio produced by the computer system, a device capturing images of the display, or a device capturing the audio produced by the computer system.

In some implementations, the signals from the sensors include video signals, and identifying the potential privacy threat includes identifying, by the computer system, an object of interest in a scene represented by the video signals; and
in response, determining, by the computer system, that the object of interest is a potential privacy threat.

In some cases, the signals from the sensors include audio signals, and identifying the potential privacy threat includes identifying, by the computer system, a speaker other than the registered user as the potential privacy threat based on the audio signals.

In some cases, the second privacy level includes one or more privacy restrictions that are not included in the first privacy level.

In some implementations, the one or more privacy restrictions include suspending an application being executed by the computer system, locking the computer system, preventing private content from being displayed on the display of the computer system, or muting audio signals being produced by the computer system.

In some implementations, operating the computer system at the second privacy level includes at least one of notifying the registered user of the potential privacy threat, or notifying an administrator of the potential privacy threat.

In accordance with embodiments of the present disclosure, a system for identifying potential privacy threats comprising includes a computer system including at least one processor, a memory, and one or more sensors. The computer system is configured to perform operations including: identifying a registered user physically located proximate to the computer system based on signals from the sensors; in response to identifying the registered user, operating the computer system at a first privacy level; identifying a potential privacy threat physically located proximate to the computer system based on the signals from the sensors, wherein the potential privacy threat is separate from the registered user; and in response to identifying the potential privacy threat, operating the computer system at a second privacy level different from the first privacy level.

In accordance with embodiments of the present disclosure, an article of manufacture includes a non-transitory, computer-readable medium having computer-executable instructions thereon that are executable by a processor of a computer system to perform operations for identifying potential privacy threats. The operations include identifying a registered user physically located proximate to the computer system based on signals from one or more sensors of the computer system; in response to identifying the registered user, operating the computer system at a first privacy level; identifying a potential privacy threat physically located proximate to the computer system based on the signals from the sensors, wherein the potential privacy threat is separate from the registered user; and in response to identifying the potential privacy threat, operating the computer system at a second privacy level different from the first privacy level.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of example components of a system for identifying potential privacy threats, in accordance with embodiments of the present disclosure;

FIG. 3 illustrates a block diagram of an example process for identifying potential privacy threats, in accordance with embodiments of the present disclosure;

FIG. 4 illustrates a block diagram of an example scene in which potential privacy threats can be identified, in accordance with embodiments of the present disclosure;

FIG. 5 illustrates a flow chart of an example process for identifying potential privacy threats, in accordance with embodiments of the present disclosure.

### DETAILED DESCRIPTION OF THE INVENTION

As described above, user presence detection enables the detection and authentication of registered users based on their face, voice, or other factors. The present disclosure describes techniques for using these same systems to identify threats to the user's privacy while the user is engaged with a computer system. For example, while the user is engaged in a video conference, another person may be viewing the video of the conference over the user's shoulder, or listening to the audio of the conference from nearby. This eavesdropper may not be authorized to know the information being discussed on the video conference, and thus represents a potential privacy threat to the user and/or the user's employer. Using user presence detection techniques, this potential privacy threat can be identified in real-time, for example based on analysis of the captured video and audio signals, and corrective action can be taken. For example, the system may notify the user of potential privacy threat, lock the system while the potential privacy threat is present, suspend the video conferencing application, pause the video and mute the audio of the video conferencing application, or perform other actions to protect the user's privacy from the detected potential threat. In some cases, the system may also detect the presence of nearby listening or video capture devices, and take similar actions. Such a system may protect the user from unwanted privacy intrusions, malicious or otherwise, and the user and its organization from potential security risks such as the unauthorized dissemination of sensitive information to unauthorized users.

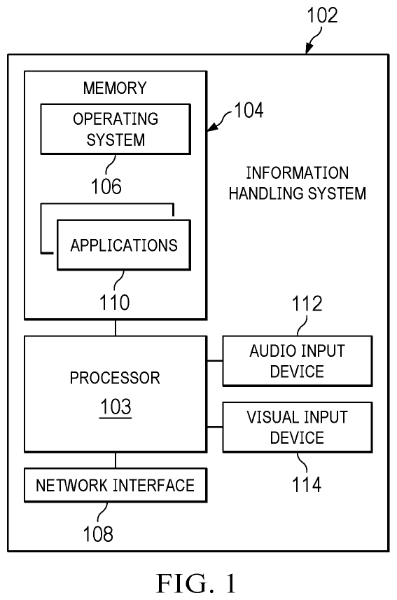

Preferred embodiments and their advantages are best understood by reference to FIGS. 1 through 5, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, and a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Memory 104 may also have stored thereon one or more applications 110. Each of the applications 110 may comprise any program of executable instructions (or aggregation of programs of executable instructions) configured to make use of the hardware resources of the information handling system 102, such as memory, processor time, disk space, input and output devices (e.g., 112, 114), and the like. In some implementations, the applications 110 may interact with the operating system 106 to make of the hardware resources, and the operating system 106 may manage and control the access of the applications 110 to these resources (as described above).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, information handling system 102 may include more than one processor 103. For example, one such processor 103 may be a CPU, and other processors 103 may include various other processing cores such as application processing units (APUs) and graphics processing units (GPUS).

Information handling system 102 further includes an audio input device 112 communicatively coupled to processor 103. Audio input device 112 can be any device (e.g., a microphone) operable to detect audible signals (i.e., sound waves) in the environment external to the information handling system 102, and convert those audible signals into electrical signals. These electrical signals representing the detected audible signals can be provided to the processor 103 where they can be analyzed and interpreted, the direction of applications 110 and/or operating system 106. In some cases, the audio input device 112 can be integrated into the information handling system 102, such as in the case of a built-in microphone. The audio input device 112 may also be an external device communicatively coupled to the information handling system 102, such as an external microphone connected via Universal Serial Bus (USB).

Information handling system 102 further includes an visual input device 114 communicatively coupled to processor 103. Visual input device 114 can be any device operable to detect electromagnetic radiation, such as visible light, and it into representative electrical signals. These convert electrical signals representing the detected electromagnetic radiation can be provided to the processor 103 where they can be analyzed and interpreted, for example at the direction of applications 110 and/or operating system 106. In some cases, the visual input device 114 can be complementary metal-oxide-semiconductor (CMOS) sensor, a charge coupled device (CCD) sensor, or another type of sensor operable to detect electromagnetic radiation. In some implementations, the visual input device 114 may be configured to detect a particular range of wavelengths of electromagnetic radiation, such as the visual light range, the ultraviolet range, the infrared range, or combinations of these and other ranges. In some cases, the visual input device 114 may be a low power camera device that monitors the environment while the information handling system 102 remains in a lower power state. In some implementations, the visual input device 114 can be integrated into the information handling system 102, such as in the case of a built-in camera. The visual input device 114 may also be an external device communicatively coupled to the information handling system 102, such as an external camera connected via USB.

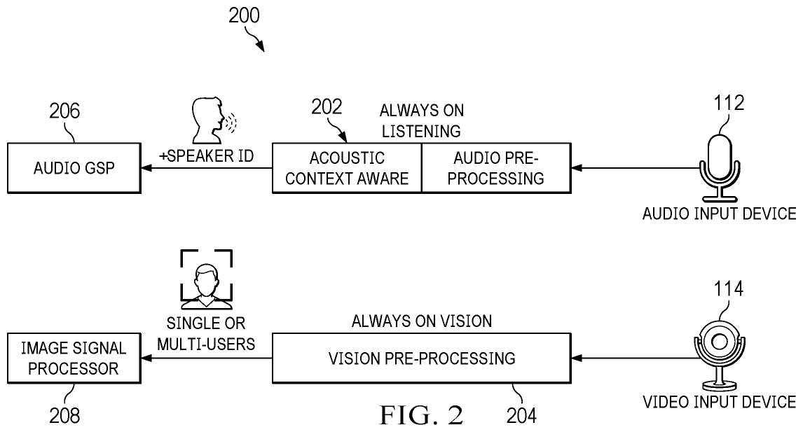

FIG. 2 illustrates a block diagram of example components of a system 200 for identifying potential privacy threats, in accordance with embodiments of the present disclosure. As shown, the system 200 includes audio input device 112 and video input device 114 previously described with respect to FIG. 1. The system 200 also includes an audio digital signal processor (DSP) 206 and an image signal processor 208. In some implementations, the audio DSP 206 and image signal processor 208 may be integrated components of the processor 103 depicted in FIG. 1. In some cases, the audio DSP 206 and image signal processor 208 may be separate components from the processor 103, and may process signals from the audio input device 112 and video input device 114, respectively, and provide processed output to the processor 103. In some implementations, the audio input device 112 and video input device 114 may be “always on” in the sense that they will continue to operate, for example in a low power mode, even when the larger system (e.g., 100) is powered down or in a standby mode.

As shown, the signals produced by the audio input device 112 and video input device 114 are pre-processed (202, 204) prior to being provided to the audio DSP 206 and image signal processor 208, respectively. For example, the audio pre-processing step 202 may include identifying vocal characteristics, such as the acoustic frequency of different voices, in order to identify each person speaking in the vicinity of the computer system 100. Similarly, For example, the video pre-processing step 202 may include identifying one or more users in the field of view of video input device 114. Such identification may be performed using facial recognition techniques, such as those that are well-known in the art. In some cases, the speakers identified from the audio signals may be correlated with the users identified from the video signals. In some implementations, the audio and video pre-processing steps 202, 204 may be performed by at least one machine learning co-processor, which may be separate components or integrated into audio input device 112 and video input device 114. The machine learning co-processor may be a dedicated processor executing well-known artificial intelligence (AI) algorithms in order to perform the pre-processing tasks. The machine learning co-processor may be configured to operate in a low power mode along with the audio input device 112 and video input device 114 to enable the “always on” functionality described above.

In some implementations, the operations depicted in FIG. 2 may be controlled (or “orchestrated”) by the operating system 106 shown in FIG. 1. This may enable the operating system 106 to implement privacy restrictions based on the detection of potential privacy threats, such as onlookers or eavesdroppers, based on the audio and video signals captured by the audio input device 112 and video input device 114.

Although the examples throughout the present specification refer generally to presence detection techniques based on the audio and video signals captured by the audio input device 112 and video input device 114, in some implementations, user presence may be detected based on a wide range of signal types, including ultrasound signals, WiFi Doppler signals, ultra wideband (UWB) signals, radio frequency (RF) radar signals, or any combination of signal types.

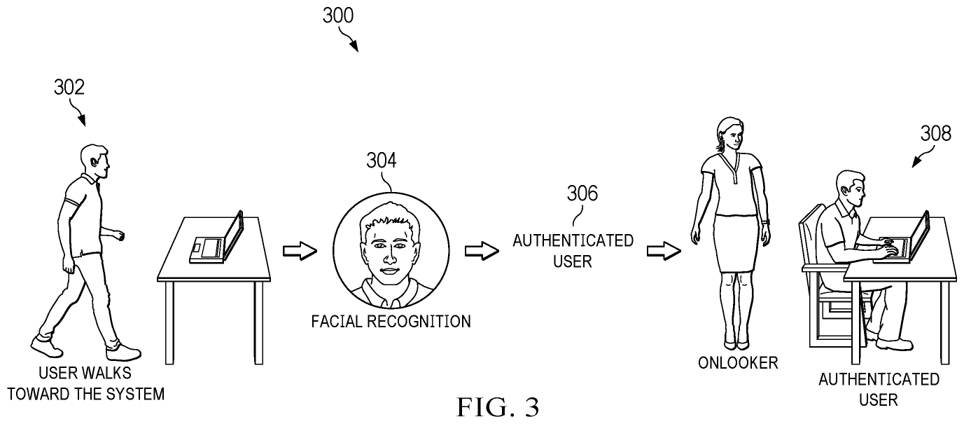

FIG. 3 illustrates a block diagram of an example process 300 for identifying potential privacy threats, in accordance with embodiments of the present disclosure. As shown, at 302, a user approaches the computer system, where its presence is detected based on, for example, the audio and video signals from the audio input device 112 and video input device 114. At 304, a facial recognition check is performed, and the user is authenticated based on this check at 306. At 308, an onlooker has approached the authenticated user while using the system. In some cases, based on the audio, video, and other signals, the system may identify this onlooker as a potential security threat, and may transition to operating in a more secure state (e.g., a different privacy level). For example, if the authenticated user is using a video conferencing application, the system may pause the video feed and mute the sound of the conference in response to detecting the onlooker. The system may also notify the authenticated user of the presence of the onlooker, and instruct the authenticated user that the authenticated user should secure their work environment (e.g., by moving to a different location, asking the onlooker to leave, etc.) before continuing the video conference.

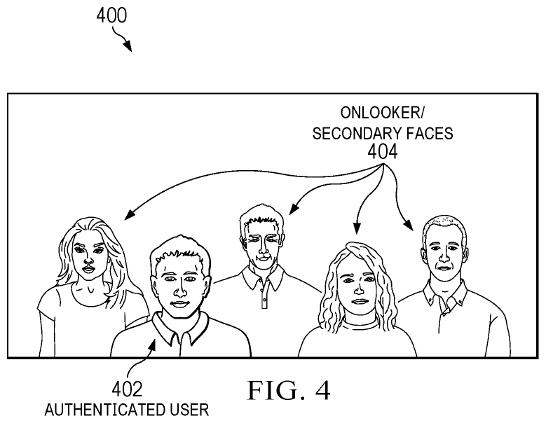

FIG. 4 illustrates a block diagram of an example scene 400 in which potential privacy threats can be identified, in accordance with embodiments of the present disclosure. As shown, the scene 400 includes one authenticated user 402 and four onlookers 404. As described above, in response to the identification of such a scene, the system may transition to a different privacy level including additional privacy restrictions. For example, the system may be locked and an instruction may be displayed to authenticated user 402 to move to a more secure environment away from onlookers 404.

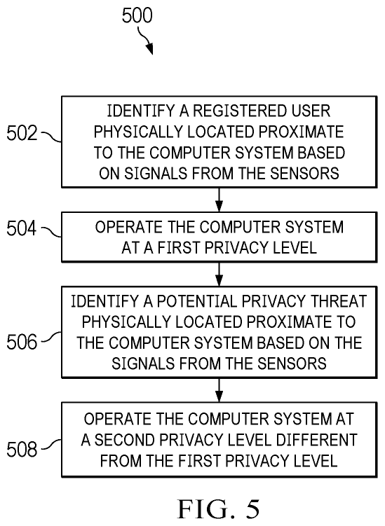

FIG. 5 illustrates a flow chart of an example process 500 for identifying potential privacy threats, in accordance with embodiments of the present disclosure. In some implementations, process 500 may be performed by a computer system, such as information handling system 102.

At 502, a registered user physically located proximate to the computer system is identified based on signals from one or more sensors. In some cases, the signals from the sensors include one or more of video signals, audio signals, ultrasound signals, WiFi Doppler signals, ultra wideband (UWB) signals, or radio frequency (RF) radar signals.

At 504, in response to identifying the registered user, the computer system is operated at a first privacy level.

At 506, a potential privacy threat physically located proximate to the computer system is identified based on the signals from the sensors. In some cases, the potential privacy threat is separate from the registered user. In some implementations, the potential privacy threat includes at least one of a non-registered user onlooker viewing a display of the computer system, a non-registered user listener listening to audio produced by the computer system, a device capturing images of the display, or a device capturing the audio produced by the computer system. In some implementations, the signals from the sensors include video signals, and identifying the potential privacy threat includes identifying an object of interest in a scene represented by the video signals, and in response, determining that the object of interest is a potential privacy threat. In some cases, the signals from the sensors include audio signals, and identifying the potential privacy threat includes identifying a speaker other than the registered user as the potential privacy threat based on the audio signals.

At 508, in response to identifying the potential privacy threat, the computer system is operated at a second privacy level different from the first privacy level. In some cases, the second privacy level includes one or more privacy restrictions that are not included in the first privacy level. For example, the one or more privacy restrictions may include suspending an application being executed by the computer system, locking the computer system, preventing private content from being displayed on the display of the computer system, or muting audio signals being produced by the computer system. In some cases, operating the computer system at the second privacy level includes at least one of notifying the registered user of the potential privacy threat, or notifying an administrator of the potential privacy threat.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for identifying potential privacy threats comprising:
identifying, by a computer system having at least one processor and a memory, a registered user physically located proximate to the computer system based on signals from one or more sensors of the computer system;
in response to identifying the registered user, operating the computer system at a first privacy level;
identifying, by the computer system, a potential privacy threat physically located proximate to the computer system based on the signals from the sensors, wherein the potential privacy threat is separate from the registered user; and
in response to identifying the potential privacy threat, operating the computer system at a second privacy level different from the first privacy level.

2. The method of claim 1, wherein the signals from the sensors include one or more of video signals, audio signals, ultrasound signals, WiFi Doppler signals, ultra wideband (UWB) signals, or radio frequency (RF) radar signals.

3. The method of claim 1, wherein the potential privacy threat includes at least one of a non-registered user onlooker viewing a display of the computer system, a non-registered user listener listening to audio produced by the computer system, a device capturing images of the display, or a device capturing the audio produced by the computer system.

4. The method of claim 1, wherein the signals from the sensors include video signals, and identifying the potential privacy threat includes:
identifying, by the computer system, an object of interest in a scene represented by the video signals; and
in response, determining, by the computer system, that the object of interest is a potential privacy threat.

5. The method of claim 1, wherein the signals from the sensors include audio signals, and identifying the potential privacy threat includes:
identifying, by the computer system, a speaker other than the registered user as the potential privacy threat based on the audio signals.

6. The method of claim 1, wherein the second privacy level includes one or more privacy restrictions that are not included in the first privacy level.

7. The method of claim 6, wherein the one or more privacy restrictions include suspending an application being executed by the computer system, locking the computer system, preventing private content from being displayed on the display of the computer system, or muting audio signals being produced by the computer system.

8. The method of claim 1, wherein operating the computer system at the second privacy level includes at least one of notifying the registered user of the potential privacy threat, or notifying an administrator of the potential privacy threat.

9. A system for identifying potential privacy threats comprising:
a computer system including at least one processor, a memory, and one or more sensors, and configured to perform operations including:
identifying a registered user physically located proximate to the computer system based on signals from the sensors;
in response to identifying the registered user, operating the computer system at a first privacy level;
identifying a potential privacy threat physically located proximate to the computer system based on the signals from the sensors, wherein the potential privacy threat is separate from the registered user; and
in response to identifying the potential privacy threat, operating the computer system at a second privacy level different from the first privacy level.

10. The system of claim 9, wherein the signals from the sensors include one or more of video signals, audio signals, ultrasound signals, WiFi Doppler signals, ultra wideband (UWB) signals, or radio frequency (RF) radar signals.

11. The system of claim 9, wherein the potential privacy threat includes at least one of a non-registered user onlooker viewing a display of the computer system, a non-registered user listener listening to audio produced by the computer system, a device capturing images of the display, or a device capturing the audio produced by the computer system.

12. The system of claim 9, wherein the signals from the sensors include video signals, and identifying the potential privacy threat includes:
identifying, by the computer system, an object of interest in a scene represented by the video signals; and
in response, determining, by the computer system, that the object of interest is a potential privacy threat.

13. The system of claim 9, wherein the signals from the sensors include audio signals, and identifying the potential privacy threat includes:
identifying, by the computer system, a speaker other than the registered user as the potential privacy threat based on the audio signals.

14. The system of claim 9, wherein the second privacy level includes one or more privacy restrictions that are not included in the first privacy level.

15. The system of claim 14, wherein the one or more privacy restrictions include suspending an application being executed by the computer system, locking the computer system, preventing private content from being displayed on the display of the computer system, or muting audio signals being produced by the computer system.

16. The system of claim 9, wherein operating the computer system at the second privacy level includes at least one of notifying the registered user of the potential privacy threat, or notifying an administrator of the potential privacy threat.

17. An article of manufacture comprising a non-transitory, computer-readable medium having computer-executable instructions thereon that are executable by a processor of a computer system to perform operations for identifying potential privacy threats, the operations comprising:
identifying a registered user physically located proximate to the computer system based on signals from one or more sensors of the computer system;
in response to identifying the registered user, operating the computer system at a first privacy level;
identifying a potential privacy threat physically located proximate to the computer system based on the signals from the sensors, wherein the potential privacy threat is separate from the registered user; and
in response to identifying the potential privacy threat, operating the computer system at a second privacy level different from the first privacy level.

18. The article of claim 17, wherein the signals from the sensors include one or more of video signals, audio signals, ultrasound signals, WiFi Doppler signals, ultra wideband (UWB) signals, or radio frequency (RF) radar signals.

19. The article of claim 17, wherein the potential privacy threat includes at least one of a non-registered user onlooker viewing a display of the computer system, a non-registered user listener listening to audio produced by the computer system, a device capturing images of the display, or a device capturing the audio produced by the computer system.

20. The article of claim 17, wherein the signals from the sensors include video signals, and identifying the potential privacy threat includes:
identifying, by the computer system, an object of interest in a scene represented by the video signals; and
in response, determining, by the computer system, that the object of interest is a potential privacy threat.
